(19) United States
(12) Patent Application Publication
(10) Pub. No.: US 2016/0048781 A1
(43) Pub. Date: Feb. 18, 2016

(54) Cross Dataset Keyword Rating System

(71) Applicant: Bank of America Corporation, Charlotte, NC (US)

(72) Inventors: Daniel C. Kern, Charlotte, NC (US); Pasha M. Maher, Charlotte, NC (US)

(21) Appl. No.: 14/459,090

(22) Filed: Aug. 13, 2014

(51) Int. Cl. G06Q 10/06; G06F 17/27

(52) U.S. Cl. CPC G06Q 10/0635; G06F 17/2765

(57) ABSTRACT

A system may include an interface, a memory, and one or more processors. The system receives a request to determine a significance of a first keyword and accesses a first record comprising the first keyword. The system determines a first risk score of the first record and assigns the first risk score of the first record as a first keyword instance score associated with the first keyword. The system determines the significance of the first keyword based at least in part upon the first keyword instance score. The system analyzes the significance of the first keyword.

### TECHNICAL FIELD

This invention relates generally to dataset analysis, and more specifically to a cross dataset keyword rating system.

### BACKGROUND

Enterprises and financial institutions create and store a plurality of records in one or more databases containing information regarding risks the enterprise faces, process measurements the enterprise monitors, and losses and issues experienced by the enterprise. Current cross dataset rating systems are limited.

### SUMMARY OF EXAMPLE EMBODIMENTS

According to embodiments of the present disclosure, disadvantages and problems associated with cross dataset keyword rating and analysis may be reduced or eliminated.

In certain embodiments, a system may include an interface, a memory, and one or more processors. The system receives a request to determine a significance of a first keyword and accesses a first record comprising the first keyword. The system determines a first risk score of the first record and assigns the first risk score of the first record as a first keyword instance score associated with the first keyword. The system determines the significance of the first keyword based at least in part upon the first keyword instance score. The system analyzes the significance of the first keyword.

Certain embodiments of the present disclosure may provide one or more technical advantages. In certain embodiments, a system for cross dataset keyword rating and analysis automatically updates the risk score of a record based on the significance of the keywords contained within the record, thereby conserving computational resources required to recalculate each risk score and constantly updating the accuracy of the system.

In certain embodiments, a system for cross dataset keyword rating and analysis generates information for display regarding the significance of one or more keywords that allow an administrator to readily identify the keywords with the largest significance, which indicates the keywords associated with the most severe items the enterprise faces. This system conserves computational resources when comparing the significance of the keywords and allows an administrator to more readily identify the most significant keywords.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and for further features and advantages thereof reference is now made to the following description taken in conjunction with the accompanying drawings, in which:

FIG. 1 illustrates an example system that facilitates cross dataset keyword rating and analysis;

FIG. 2A illustrates an example graph of information for display related to the distribution of a plurality of keyword instance scores;

FIG. 2B illustrates an example graph of information for display related to the comparison of significance of a first keyword over a time interval;

FIG. 2C illustrates an example tree map showing the significance of a plurality of keywords;

FIG. 3 illustrates an example flowchart for facilitating cross dataset keyword rating and analysis;

FIG. 3A illustrates an example flowchart for facilitating determining a distribution of a plurality of keyword instance scores;

FIG. 3B illustrates an example flowchart for facilitating comparing the significance of a first keyword over a time interval;

FIG. 3C illustrates an example flowchart for facilitating generating a tree map to show the significance of a plurality of keywords; and

FIG. 3D illustrates an example flowchart for facilitating determining and comparing various risk scores of the same record.

### DETAILED DESCRIPTION

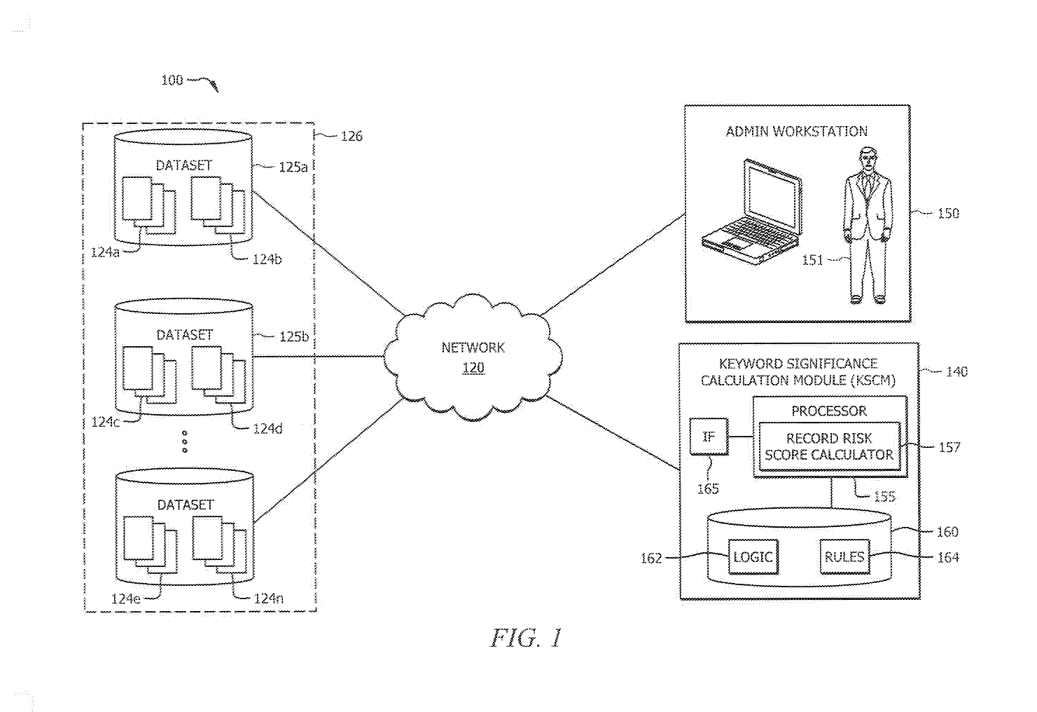

Embodiments of the present invention and its advantages are best understood by referring to FIGS. 1-3D, like numerals being used for like and corresponding parts of the various drawings.

Banks, business enterprises, and other financial institutions that conduct transactions with customers may gather and analyze data regarding various risks to the enterprise, including operational risk. The teachings of this disclosure recognize that it would be desirable to have a system that can rate keywords across different types of datasets with various levels of severity, creating a normalized scale to facilitate comparison of the severity of the risks, metrics, losses, and issues and keywords associated with those items.

FIG. 1 illustrates an example system 100 that facilitates cross dataset keyword rating and analysis. System 100 may include administrator workstation 150, administrator 151, system of record 126, one or more datasets 125a-125n, network 120, and Keyword Significance Calculation Module (KSCM) 140. Administrator workstation 150, one or more datasets 125, and KSCM 140 may be communicatively coupled by network 120.

In general, KSCM 140 may receive a request from administrator workstation 150 to determine a significance of a first keyword, KSCM 140 may access record 124 from dataset 125 comprising the first keyword. KSCM 140 may determine a first risk score of the first record and assigns the first risk score of the first record as a first keyword instance score associated with the first keyword. KSCM 140 may determine the significance of the first keyword based at least in part upon the first keyword instance score. KSCM 140 may analyze the significance of the first keyword using information about the frequency of the first keyword, the significance of the first keyword over a time period, or the distribution of the plurality of keyword instance scores.

Administrator workstation 150 may refer to any device that facilitates administrator 151 performing a function in system 100, in some embodiments, administrator workstation 150 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Administrator workstation 150 may also comprise any suitable user interface such as a display, microphone, keyboard, or any other appropriate terminal equipment usable by administrator 151. It will be understood that system 100 may comprise any number and combination of administrator workstations 150. Administrator 151 utilizes administrator workstation 150 to interact with KSCM 140 to request to determine a significance of a first keyword and receive information communicated from KSCM 140 for display, as described below.

Network 120 may refer to any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

System of record 126 may comprise one or more datasets 125. Datasets 125 may be a group of records 124 pertaining to the same field or branch of the enterprise. For example, datasets 125 may include operational loss data, metrics, issues, risks, and external loss data. In some embodiments, records 124 contain information relating to items from a particular dataset 125. For example, records 124 may be a record created by administrator 151 after the enterprise encounters any problems, such as a loss of money, a malfunction in a system, or when a fraud occurs. Continuing to the example, administrator 151 may create record 124 to save information related to the item, such as what the problem was, what occurred., how it was resolved, and the loss suffered by the enterprise. In some embodiments, record 124 may include a rating for the severity of the item detailed by record 124. Each dataset 125 may have a different scale for rating the severity of the item. For example, dataset 125a may have a scale of Sev1-Sev3 (with Sev1 being the most severe record), while dataset 125b may have a scale of green, yellow, red (with red being the most severe record). In some embodiments, each record 124 will include a severity rating based on the item it was created to record. For example, record 124a from dataset 125a may be labeled Sev2 and record 124d from dataset 125b may be labeled green. System 100 may include any number of systems of record 126, datasets 125, severity ratings for each dataset 125, and records 124 within each dataset 125. In certain embodiments, KSCM 140 accesses records 124 to determine a risk rating of data set 125 associated with record 124 and to determine a risk score of record 124.

KSCM 140 may refer to any suitable combination of hardware and/or software implemented in one or more modules to process data and provide the described functions and operations. In some embodiments, the functions and operations described herein may be performed by a pool of KSCM 140. In some embodiments, KSCM 140 may include, for example, a mainframe, server, host computer, workstation, web server, file server, a personal computer such as a laptop, or any other suitable device operable to process data. In some embodiments, KSCM 140 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, KSCM 140 accesses records 124 comprising a keyword and determines the significance of the keyword based at least in part upon the keyword instance score from record 124. KSCM 140 may also analyze the significance of the keyword. In some embodiments, KSCM 140 may include processor 155, memory 160, and an interface 165.

Memory 160 may refer to any suitable device capable of storing and facilitating retrieval of data and/or instructions. Examples of memory 160 include computer memory (for example, RAM or ROM), mass storage media (for example, a hard disk), removable storage media (for example, a CD or a DVD), database and/or network storage (for example, a server), and/or or any other volatile or non-volatile, non-transitory computer-readable memory devices that store one or more files, lists, tables, or other arrangements of information. Although FIG. 1 illustrates memory 160 as internal to KSCM 140, it should be understood that memory 160 may be internal or external to KSCM 140, depending on particular implementations. Also, memory 160 may be separate from or integral to other memory devices to achieve any suitable arrangement of memory devices for use in system 100.

Memory 160 is generally operable to store logic 162 and rules 164. Logic 162 generally refers to algorithms, code, tables, and/or other suitable instructions for performing the described functions and operations. Rules 164 generally refer to policies or directions for determining a risk rating of dataset 125 associated with record 124 and determining a risk score of record 124. Rules 164 may be predetermined or predefined, but may also be updated or amended based on the needs of enterprise 110.

Memory 160 communicatively couples to processor 155. Processor 155 is generally operable to execute logic 162 stored in memory 160 to determine a significance of a keyword and analyze the determined significance, according to the disclosure. Processor 155 also contains record risk score calculator 157. Record risk score calculator 157 generally refers to any suitable device operable to calculate the risk score for record 124 to facilitate determining the significance of a keyword. Processor 155 may comprise any suitable combination of hardware and software implemented in one or more modules to execute instructions and manipulate data to perform the described functions for KSCM 140. In some embodiments, processor 155 may include, for example, one or more computers, one or more central processing units (CPUs), one or more microprocessors, one or more applications, and/or other logic.

In some embodiments, communication interface 165 (I/F) is communicatively coupled to processor 155 and may refer to any suitable device operable to receive input for KSCM 140, send output from KSCM 140, perform suitable processing of the input or output or both, communicate to other devices, or any combination of the preceding. Communication interface 165 may include appropriate hardware (e.g., modem, network interface card, etc.) and software, including protocol conversion and data processing capabilities, to communicate through network 120 or other communication system that allows KSCM 140 to communicate to other devices. Communication interface 165 may include any suitable software operable to access data from various devices such as datasets 125, records 124, and administrator workstation 150. Communication interface 165 may also include any suitable software operable to transmit data to various devices such as administrator workstation 150. Communication interface 165 may include one or more ports, conversion software, or both. In general, communication interface 165 may receive a request to determine a significance of a keyword, access one or more records 124 comprising the keyword, and communicate information to administrator workstation 150 for display to administrator 151.

In operation, logic 162 and rules 164, upon execution by processor 155, facilitate determining a risk rating of dataset 125 associated with record 124 and determining a significance of a keyword based on a keyword instance score. Logic 162 and rules 164 also facilitate calculating a risk score of record 124 as determined by record risk score calculator 157.

In some embodiments, record risk score calculator 157 represents any suitable device operable to calculate risk scores for record 124. For example, record risk score calculator 157 may analyze certain characteristics of record 124 (e.g., length, wording, size, author, date) in order to calculate the risk score. In certain embodiments, record risk score calculator 157 may determine a risk rating of dataset 125 associated with record 124. For example, if dataset 125c contains records 124 regarding information on risks to the enterprise, three possible risk ratings may be high risk, medium risk, and low risk. Record risk score calculator 157 may determine whether record 124c is in the high risk, medium risk, or low risk category. Continuing the example, record risk score calculator 157 may determine that record 124c has already been assigned a risk rating (e.g., by the author of record 124c) or may analyze the characteristics of record 124 to determine the risk rating.

In certain embodiments, the risk rating determined by record risk score calculator 157 is associated with a risk rating score. For example, if record risk score calculator 157 determines record 124c is in the medium risk category, it may determine the risk rating score is 0.5. In some embodiments, record risk score calculator 157 may access a table in memory 160 or use rules 164 to determine what the risk rating score (e.g., 0.5) corresponding to the risk rating (e.g., medium risk category) is. In some embodiments, this table or information may include all the different risk ratings and risk rating scores on a single scale, such that they may be compared to each other in terms of severity. For example, each dataset 125a through 125n may contain records 124 of a certain type (e.g., operational loss, metrics, issues, risks, and external loss data) with different risk ratings (e.g., green, yellow, and red or Sev1, Sev2, and Sev3) that each correspond to a different risk rating score (e.g., 0.9, 0.7, and 0.4, or 0.8, 0.5, 0.3). The various risk rating scores may be on any scale from 0 to 1, 0 to 100, 0 to 4.0, or 7 to 22.

The table or scale in memory 160 or rules 164 used by record risk score calculator 157 to determine the risk rating score (e.g., 100) corresponding to the risk rating of record 124 (e.g., Sev 2) may be created in any number of ways. In certain embodiments, subject matter experts may rank the various risk ratings from different datasets 125 against each other. For example, one subject matter expert may rank the various risk ratings from different datasets (e.g., metrics (red, yellow, green risk), operational loss (value of loss in dollars), and issues (Sev1, Sev2, Sev3) in order of severity as: Sev1, red risk, $10,000,000, yellow risk, Sev2, Sev3, $1,000,000, yellow risk, green risk, $100,000. Continuing the example, the various rankings from a plurality subject matter experts may be combined, analyzed, and normalized onto a single scale (e.g., 0 to 1, 0 to 100). In certain embodiments, record risk score calculator 157 will use this scale to determine the risk rating score corresponding to the risk rating of record 124 (e.g., record 124 from the issues dataset 125 may have a risk rating of Sev 1, which the scale indicates has a score of 0.97). The scale or table may be updated at any time by administrator 151 or by rules 164 of KSCM 140.

It will be understood that record risk score calculator 157 may determine any number of risk scores for one or more records 124. Although FIG. 1 illustrates 157 as internal to KSCM 140 and processor 155, it should be understood that 157 may be internal or external to KSCM 140 and processor 155, depending on particular implementations. Also, memory 160 may be separate from or integral to other memory devices to achieve any suitable arrangement of memory devices for use in system 100.

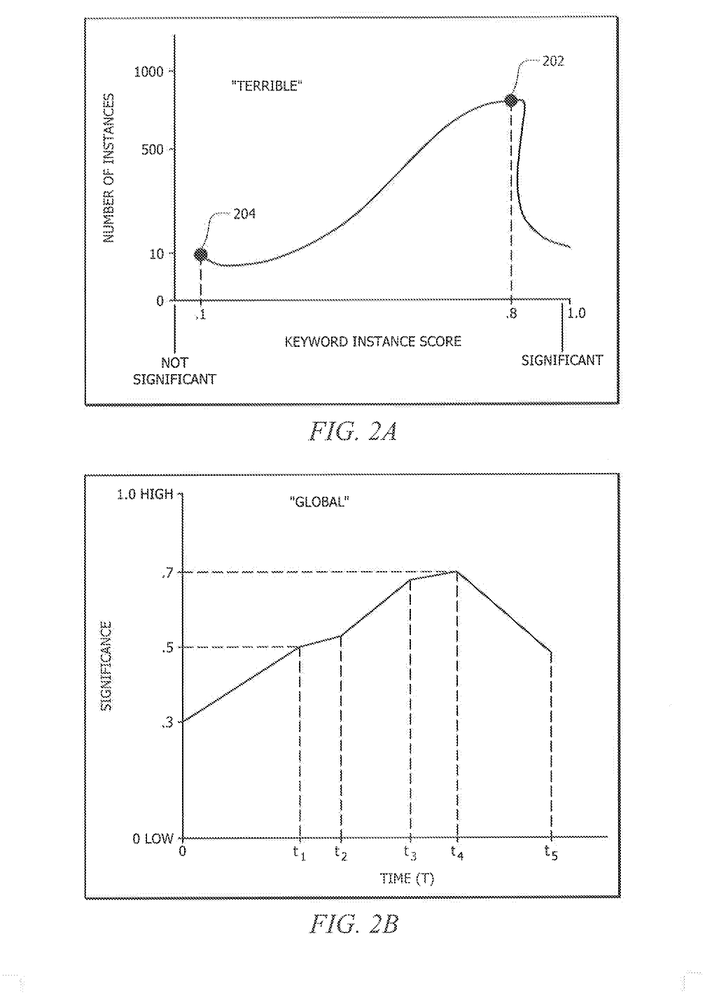

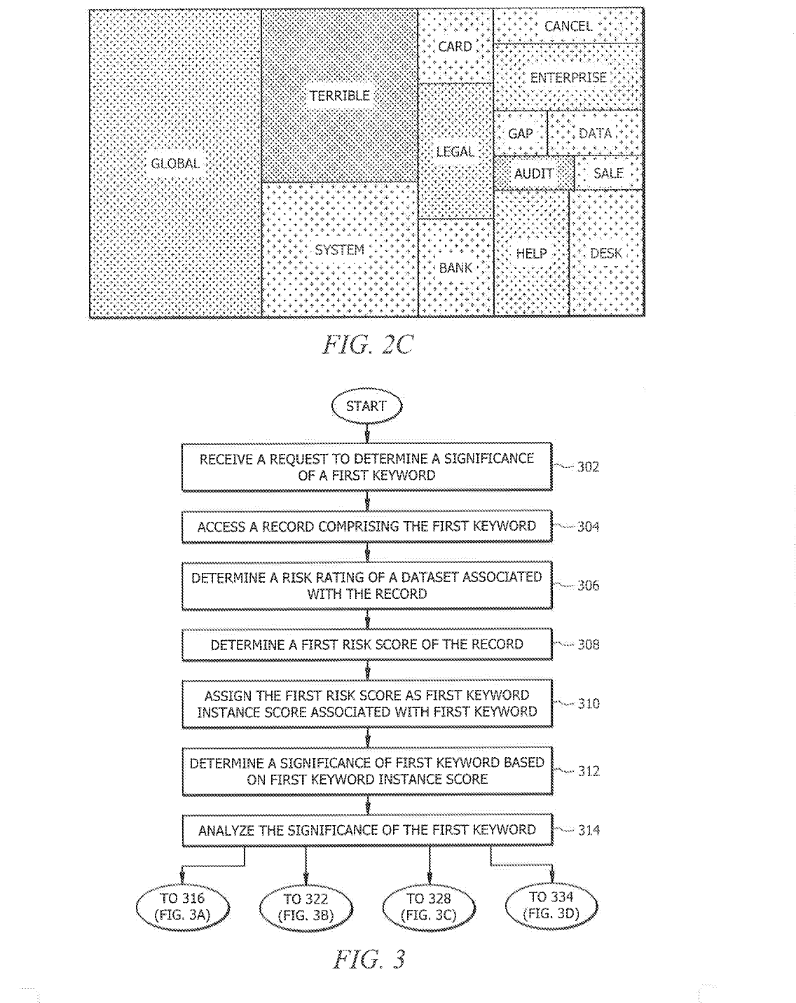

In some embodiments, KSCM 140 may receive a request to determine a significance of a keyword. KSCM 140 may receive the request at interface 165 from administrator workstation 150 via network 120. In some embodiments, the request may include one or more keywords. For example, administrator 151 may request KSCM 140 to determine the significance of “global” and the significance of “audit” based on records 124 in datasets 125a through 125n. The request may also include a request for a specific type of feedback, such as generating a tree map (see FIG. 2C below), information for display related to the comparison of the significance of a keyword at two different points in time (see FIG. 2B below), or information for display related to the distribution of a plurality of keyword instance scores for the requested keyword(s) (see FIG. 2A below). The request may be for one or more types of feedback, visual information, or report.

In some embodiments, KSCM 140 may access record 124 comprising the keyword. KSCM 140 may access one or more records 124 comprising the keyword. For example, KSCM 140 may access each record 124 that comprises the keyword at least once, access each record 124 that comprises the keyword above a threshold number of times (e.g., 10), or may access the one hundred records 124 that comprise the most instances of the keyword.

In some embodiments, KSCM 140 may assign the risk score of record 14 (e.g., determined by record risk score calculator 157) as a keyword instance score associated with the requested keyword. There may be any number of keyword instances scores associated with the requested keyword. In some embodiments, KSCM 140 assigns a separate keyword instance score for each record 124 that contains the keyword. For example, if “global” appears in records 124a (with a risk score of 0.5), 124b (with a risk score of 0.4), 125d (with a risk score of 0.9), and 124e (with a risk score of 0.5), then KSCM 140 may assign four separate keyword instance scores of 0.5, 0.4, 0.9, and 0.5.

In some embodiments, KSCM 140 may determine the significance of the keyword based at least in part upon the keyword instance score. In some embodiments, the significance of the keyword is based on multiple keyword instance scores. From the example above, if the keyword “global” has four keyword instance scores (each from a different record 124), then KSCM 140 may determine the significance of “global” based on those four keyword instance scores. In some embodiments, KSCM 140 averages the multiple keyword instance scores to determine the significance of the keyword. For example, if the keyword instance scores are 0.5, 0.4, 0.9, and 0.5, then the significance of “global” would be 0.55. KSCM 140 may use any mathematical operation to determine the significance of the keyword, for example, the average, the mean, the medium, the summation, or the product. In some embodiments, KSCM 140 may use only some of the keyword instance scores. For example, KSCM 140 may determine if any of the scores are outliers such that they should not be included in the determination of the significance. In some embodiments, KSCM 140 may determine that the significance of the keyword is “0” or “undefined” because there are not enough instances where the keyword appears in records 124 to determine any actual significance.

In some embodiments, KSCM 140 may analyze the significance of the keyword. KSCM 140 may create a list of records 124 that contain the keyword and a secondary list that shows other keywords that appear in the same records 124 as the requested keyword. For example, KSCM 140 may show that the keyword “global” is often included in records 124 that also contain a separate keyword “terrible.” Continuing the example, KSCM 140 may allow administrator 151 to further view a list of keywords (and their respective significances) that often appear in records that also contain the keywords “global” and “terrible,” for example “anti-money laundering.” This analysis allows administrator 151 to quickly determine or identify potential operational risks, for example, that many “terrible” “anti-money laundering” records also involved some sort of “global” aspect. KSCM 140 may analyze the significance of a keyword in any number of ways including, determining a distribution of a plurality of keyword instance scores, generating a visual (e.g., a tree map), and comparing the significance of the keyword at various points in time, as discussed below.

A component of system 100 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to the systems described herein without departing from the scope of the invention. For example, system 100 may include any number of administrators 151, administrator workstations 150, networks 120, KSCMs 140, and datasets 125. Moreover, the operations may be performed by more, fewer, or other components. For example, determining a risk rating of dataset 125 associated with record 124, determining an risk rating score, and determining a risk score of record 124 may be performed by record risk score calculator 157 or KSCM 140 itself. Additionally, the operations may be performed using any suitable logic comprising software, hardware, and/or other logic. As used in this document, “each” refers to each member of a set or each member of a subset of a set.

FIGS. 2A, 2B, and 2C illustrate examples of information for display related to various aspects of the significance of a keyword. These visualizations are the result of KSCM 140 analyzing the significance of the keyword. These figures are meant for illustrative purposes and should not be construed as limiting.

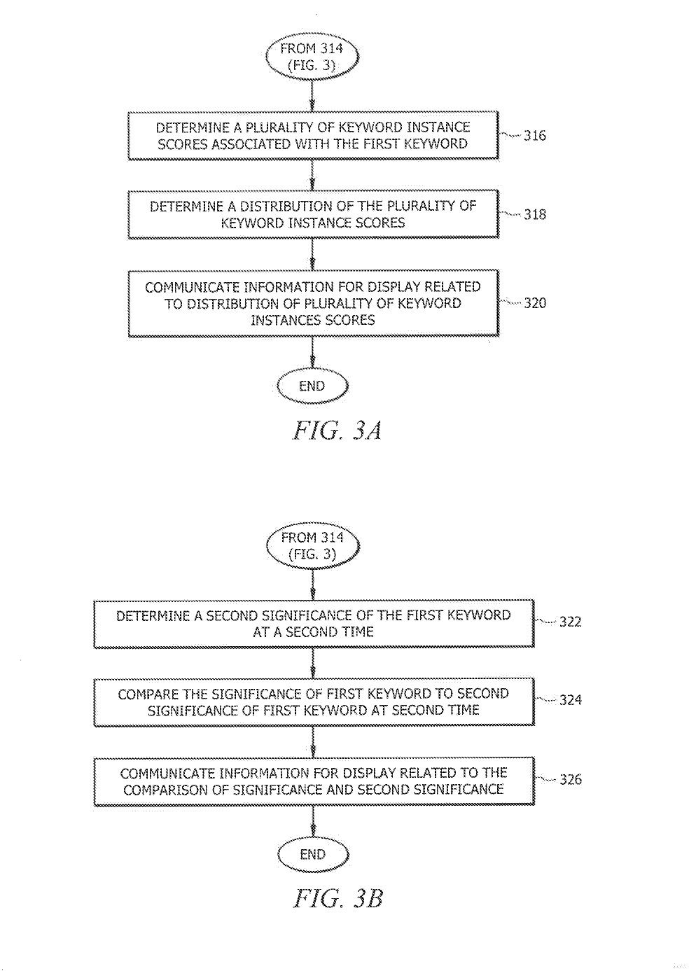

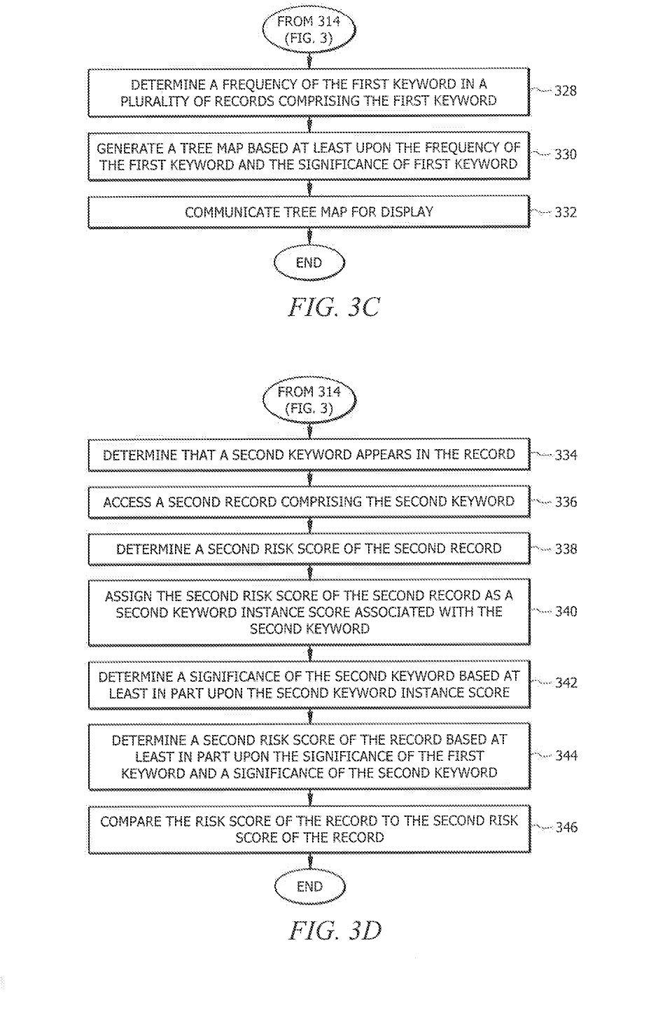

FIG. 2A illustrates an example graph of information for a display related to the distribution of a plurality of keyword instance scores. FIG. 2A may be generated using one or more of the techniques discussed below with respect to steps 316-320 of FIG. 3A. The graph of FIG. 2A includes a keyword instance score on the X axis and numbered instances on the Y axis. The number of instances ranges from 0 to 1,000. The number of keyword instance scores ranges from 0 to 1.0, where 1.0 represents a very significant keyword instance score and a keyword instance score of 0 represents a not significant or insignificant keyword instance score. FIG. 2A depicts the distribution of keyword instance scores of a particular keyword. For example, the keyword for this graph may be the keyword “terrible.” KSCM 140 may aggregate the plurality of keyword instance scores for “terrible” and determine the number of instances that each keyword instance score was assigned to “terrible” to generate the graph in FIG. 2A. For example, marker 204 shows a keyword instance score of 0.1 and number of instances of 10. This represents that for the keyword “terrible,” there were 10 instances or 10 records 124 where the keyword instance score or the record risk score was 0.1. Dot 202 shows a keyword instance score of 0.8 and instances of 1,000. This represents that for the keyword “terrible” there were 1,000 instances or 1,000 records 124 where the record risk score and thus the keyword instance score was 0.8.

KSCM 140 may communicate this information to administrator workstation 150 such that the graph may be displayed to administrator 151 after a request was submitted to KSCM 140 to determine the significance of the keyword “terrible.” FIG. 2A may be beneficial to administrator 151 because it shows the range and distribution of keyword instance scores for a particular keyword. For example, using FIG. 2A, administrator 151 could see that most often “terrible” appears in records 124 with a record risk score (and thus it is assigned a keyword instance score) of around 0.7 to 0.8. FIG. 2A also allows administrator 151 to understand that there is a large range of keyword instance scores—from 0.1 to 1.0. The range may be significant to administrator 151 in determining whether the significance determined by KSCM 140 is consistent with the range determined on a record by record basis.

FIG. 2B illustrates an example graph of information for display related to the comparison of significance of a first keyword over a time interval. FIG. 2B may be generated using one or more of the techniques discussed below with respect to steps 322-326 of FIG. 3B. In FIG. 2B, the Y axis illustrates the significance of a keyword ranging from a low significance (e.g., 0) to a high significance (e.g., 1.0) in this example. The X axis illustrates a time T with 5 instances of a specific time T1, T2, T3, T4 and T5. In this example, FIG. 2B represents the calculated significance of keyword “global” over a time interval T. At time 0, the significance is shown to be 0.3. Time 0 may represent the first time that KSCM 140 determines the significance of the keyword “global.” From time 0 to time T1, the graph shows an increase in significance of the keyword “global” to 0.5. At time T2, there is only slight raise in significance of keyword “global,” but at time T3 the significance of “global” increases to almost 0.7. Time T4 represents the peak of significance at 0.7. From time T4 to time T5, FIG. 2B shows a decrease in significance from 0.7 to around 0.55. This visualization is beneficial because it allows administrator 151 to quickly understand and determine the changing significance of the keyword over any time interval. For example, there may be more severe instances of global problems resulting in high significance of the keyword “global” during certain times of the year (e.g., during the winter), such as between time T2 and time T4. By being able to view the significance of the keyword “global” over a time period, administrator 151 is able to quickly discern the fluctuations in the significance of a keyword overtime.

FIG. 2C illustrates an example tree map showing the significance of a plurality of keywords. FIG. 2C may be generated using one or more of the techniques discussed below with respect to steps 328-332 of FIG. 3C. The tree map in FIG. 2C illustrates the words: global, terrible, system, card, legal, bank, counsel, enterprise, gap, data, audit, sale, help, and desk. The size of each square in the tree map represents the frequency that the word appears in a plurality of records 124 across multiple datasets 125. For example, the keyword “global” is in the largest box, which means that it shows up in records 124 most frequently compared to the other words displayed in the tree map. The shading of the rectangles represents the significance of the keyword, such that the darker rectangles have a higher significance and the lighter rectangles have a lower significance as determined by KSCM 140. The darkest level of shading includes “terrible” and “audit,” which shows that these two words have the highest calculated significance. The keyword “terrible” has a larger rectangle size because it appears more frequently in records 124 than “audit” does. The remaining levels of shading in order of decreasing significance includes: (1) “global” and “legal,” (2) “enterprise” and “help,” and (3) the rest of the rectangles are all white, or have the least amount of shading, which means that their significance is very low as determined by KSCM 140. In some embodiments, administrator 151 may select a subset of the rectangles to generate an additional tree map containing just the subset of rectangles. This allows for a more in depth view of these keywords in comparison to each other. In certain embodiments, administrator 151 may select a single keyword to show additional information about the keyword, such as the distribution of the keyword (e.g., FIG. 2A), the change in significance over time (e.g., FIG. 2B), the records that the keyword appears in, or any other detail regarding the keyword. It is beneficial for administrator 151 to view a tree map, such as the one shown in FIG. 2C, to be able to rapidly determine the keywords with the highest significance and the largest frequency, which are the words that may predict the largest risk to the enterprise.

Modifications, additions, or omissions may be made to the information for display described herein without departing from the scope of the invention. For example, system 100 may create any number of graphs or visuals associated with the significance of a keyword. As another example, FIGS. 2A and 2B may include information regarding the significance of a plurality of keywords, rather than just one keyword as illustrated.

FIG. 3 illustrates an example flowchart for facilitating cross dataset keyword rating and analysis. At step 302, in some embodiments, KSCM 140 receives a request to determine a significance of a first keyword. The request may come from administrator 151 at workstation 150 via network 120 to interface 165. In some embodiments, the request may include determining the significance of a plurality of keywords. For example, administrator 151 can request that KSCM 140 determines the significance for the keywords global, terrible, audit, legal and disaster. The request may also include a specific method for feedback, such as a list, report, a distribution graph (e.g., FIG. 2A), a significance over time graph (e.g., FIG. 2B), a tree map (e.g., FIG. 2C), or any other suitable form of feedback. In some embodiments, the request may be sent automatically to KSCM 140, rather than administrator 151 explicitly sending a request. For example, if administrator 151 or another user is browsing risk data, system 100 may trigger a request to determine a significance of a keyword based on what administrator 151 reads, views, hovers over, or clicks on while browsing the risk data. In this example, KSCM 140 may return the results of analyzing the significance of the keyword (e.g., a tree map) to the person browsing, or to another user.

At step 304, in some embodiments, KSCM 140 accesses a first record comprising the first keyword. KSCM 140 may access any dataset 125 within system of record 126. KSCM 140 may access any certain dataset, such as 125a and 125b, or may access all of the datasets within the enterprise. In certain embodiments, KSCM 140 may access a record only if the keyword appears a certain number of times in the record 124. For example, KSCM 140 may ignore record 124e if it includes the keyword “global” only one or two times, but may access record 124e if it includes the keyword “global” more than five times.

At step 306, in some embodiments, KSCM 140 may determine a risk rating of dataset 125 associated with record 124. The record that KSCM 140 accesses in step 302 is record 124 for which KSCM 140 determines the risk rating in step 306. For example, if record 124c is part of dataset 125b, it may determine the severity of the item that record 124c involves in order to determine the risk rating of record 124c. For example, the severity of records 124 in dataset 125 may be ranked in terms of Sev1, Sev2, and Sev3. In some embodiments, KSCM 140 determines the ranked risk rating with which record 124 is associated. For example, KSCM 140 may determine record 124C is associated with the risk rating Sev2. As another example, dataset 125 may include records 124a and b that involve information regarding risk to the enterprise, which may include the risk ratings of red risk, yellow risk, and green risk, with red risk being the highest risk and green risk being the lowest risk. Continuing the example, KSCM 140 may determine that record 124a is in the red risk category. In certain embodiments, each risk rating is associated with a risk rating score, which correlates to the severity of the risk rating. For example, dataset 125 dealing with risk to the enterprise, the red risk rating may have a risk rating score of 0.9, the yellow risk rating may have a risk rating score of 0.5, and a green risk rating may have a risk rating score of 0.3. KSCM 140 may include a plurality of datasets, risk ratings related to each dataset, and risk rating scores that may be updated at any time by administrator 151 or by rules 164 of KSCM 140.

At step 308, in some embodiments, KSCM 140 determines a first risk score of record 124 based at least in part upon the risk rating and the risk rating score determined in step 306. For example, if record 124a is determined to be in the yellow risk rating, which has a risk rating score of 0.5, then KSCM 140 may determine the risk score of record 124A is 0.5. In some embodiments, KSCM 140 determines the risk score of record 124 by accessing information that administrator 151 labeled on record 124 (e.g., the risk rating). In certain embodiments, KSCM 140 determines the risk score of record 124 by analyzing the contents of record 124 itself (e.g., the length, time, issue, start date, end date, and resolution). In some embodiments, record risk score calculator 157 may determine the record risk score for each of the plurality of records 124.

At step 310, in some embodiments, KSCM 140 assigns the first risk score of record 124 as a first keyword instance score associated with the first keyword. For example, if record risk score calculator 157 determines in step 308 that record 124c containing the word “card” has a risk score of 0.45, then KSCM 140 will assign 0.45 as a keyword instance score of keyword “card.” In some embodiments, KSCM 140 may assign multiple keyword instance scores depending on the number of records accessed in step 304. For example, if the keyword “global” appears in record 124a and 124d, then it may have two separate keyword instance scores based on the risk score of records 124a and 124d.

At step 312, in some embodiments, KSCM 140 determines the significance of the first keyword based at least in part upon the first keyword instance score determined and assigned in steps 308 and 310. If KSCM 140 accesses a plurality of records 124 in step 304, then there may be a plurality of keyword instance scores assigned in step 310 and used to determine the significance of the keyword in step 312. If the keyword “legal” has five keyword instance scores, for example, 0.1, 0.2, 0.3, 0.7 and 0.9, then KSCM 140 would determine the significance of the keyword “legal” based on all of these keyword instance score. In some embodiments, KSCM 140 may use a mathematical operation to aggregate a keyword instance scores in determining the significance of keyword. For example, KSCM 140 may take the average of all the keyword instance scores, the mean of all the keyword instance scores, the median of all the keyword instance scores, or the aggregate of all the keyword instance scores (e.g., by multiplying them together or adding them together). In some embodiments, KSCM 140 uses only a subset of keyword instance scores. For example, KSCM 140 may delete any statistical outliers from the plurality of keyword instance scores in order to determine a more accurate significance of the first keyword. For example, if the keyword legal has 25 keyword instance scores with 23 of those keyword instance scores ranging between 0.4 and 0.6, but two keyword instance scores of 0.01 and 0.99, then KSCM 140 may not consider the keyword instance scores 0.01 and 0.99 when determining the significance of the keyword “legal.”

At step 314, in some embodiments, KSCM 140 may analyze the significance of the first keyword calculated in step 312. This analysis may include the significance of one keyword or the significance of a plurality of keywords. For example, if administrator 151 requested to compare the significance between the keyword “audit” and the keyword “legal,” then KSCM 140 may analyze the significance of both. Further examples of how KSCM 140 may analyze the significance of the keyword are shown in FIGS. 3A, 3B, 3C and 3D. After KSCM 140 analyzes the significance of the keyword in step 314, the method may continue to any of the FIG. 3A, 3B, 3C, or 3D, or the method may end.

FIG. 3A illustrates an example flowchart for facilitating determining a distribution of a plurality of keyword instance scores. At step 316, in some embodiments, KSCM 140 determines a plurality of keyword instance scores associated with a keyword. KSCM 140 may determine a plurality of keyword instance scores using one or more of the techniques discussed above with respect to steps 304-310 of FIG. 3. KSCM 140 may access a plurality of records 124 comprising the first keyword in step 304 in order to determine the plurality of keyword instance scores in step 316. For each record 124 accessed in step 304, KSCM 140 may determine a keyword instance score for the keyword. For example, if the keyword “terrible” occurs in record 124a and 124c, then KSCM 140 may determine two keyword instance scores, one based on record 124a and one based on record 124c. KSCM 140 may determine any number of keyword instance scores and access any number of records 124 in order to determine the plurality of keyword instance scores associated with a keyword in step 316.

At step 318, in some embodiments, KSCM 140 may determine a distribution of the plurality of the keyword instance scores. KSCM 140 may determine the distribution by looking at the range of individual keyword instance scores. For example, KSCM 140 may determine that the lowest keyword instance score for a particular keyword as 0.1, while the highest keyword instance score is 0.7. KSCM 140 may look at each instance of the keyword instance scores to determine the distribution of significance.

At step 320, in some embodiments, KSCM 140 may communicate information for display related to the distribution of the plurality of the keyword instance scores determined in step 318. KSCM 140 may communicate this information for display from interface 165 via network 120 to administrator workstation 150. An example of the information that could be displayed is shown in FIG. 2A. Although not limited to the information shown in FIG. 2A, KSCM 140 may communicate any information related to the distribution of the plurality of keyword instance scores in step 320. For example, KSCM 140 may communicate a chart showing each keyword instance score. As another example KSCM 140 may communicate a chart showing a range of keyword instance scores and the number of instances (e.g., the number of records 124) that have that keyword instance score for the particular keyword. Communicating information related to the distribution of the keyword instance scores allows administrator 151 to see the range of keyword instance scores of the keyword and to determine the indication of risk based on the presence of the keyword in record 124. The method may continue to FIG. 3B, 3C, or 3D, or the method may end.

FIG. 3B illustrates an example flowchart for facilitating comparing the significance of a first keyword over a time interval. At step 322, in some embodiments, KSCM 140 determines a second significance of the keyword at a second time. KSCM 140 may use one or more of the techniques discussed above with respect to steps 304-312 of FIG. 3 in order to determine the second significance of the keyword at a second time. For example, KSCM 140 may determine the significance of keyword “terrible” at a first time and may determine a second significance of the keyword “terrible” one year in the future. This may allow KSCM 140 to take into account a plurality of datasets 125 and/or a plurality of records 124 that were not available at a first time.

At step 324, in some embodiments, KSCM 140 compares the significance of the first keyword to the second significance of the first keyword at a second time. KSCM 140 may compare these two significances in any way suitable. For example, KSCM 140 may determine which significance is greater, how much one significance is greater than the other, whether the two significances are equal, the increase over the time period, or the rate of change over the time period. KSCM 140 may also show which datasets 125 and records 124 were added to the significance determination from the first time to the second time (e.g., one year in the future).

At step 326, in some embodiments, KSCM 140 communicates information for display related to the comparison of the significance of the first keyword and the second significance of the first keyword. KSCM 140 may communicate this information from interface 165 via network 120 to administrator workstation 150. In some embodiments, the information may be a message showing a comparison, a chart showing the information involved in the comparison (e.g., the various datasets 125, records 124, rate of change of significance of the keyword, or the difference between the significance). In some embodiments, KSCM 140 may have information regarding only one keyword. For example, in FIG. 2B, discussed above, shows the varying significance over time interval T of the keyword “global.” In some embodiments, KSCM 140 may communicate information related to the significance of the plurality of keywords. For example, KSCM 140 may communicate a chart similar to FIG. 2B but including the significance graph for a plurality of keywords. This may allow administrator 151 to view any general trends in the rating of significance for a plurality of keywords (e.g., all keyword significance scores are increasing, all are decreasing, or some are decreasing while others are increasing and others are not changing). The method may continue to FIG. 3A, 3C, or 3D, or the method may end.

FIG. 3C illustrates an example flowchart for facilitating generating a tree map to show the significance of a plurality of keywords. At step 328, in some embodiments, KSCM 140 determines a frequency of the keyword in a plurality of records 124 comprising the first keyword. KSCM 140 may access records 124 by using one or more of the techniques discussed above with respect to step 304 of FIG. 3. In some embodiments, KSCM 140 may determine the number of records 124 in which the keyword appears (e.g., even if it appears just one time in the whole record 124). For example, KSCM 140 may determine that the keyword “terrible” occurs in 10,000 out of 100,000 records 124. In some embodiments, KSCM 140 may determine the frequency in the plurality of records depending on each time it appears, even if multiple times within one record. For example, if the keyword “terrible” occurs five times in record 124a, two times in 124b, and three times in 124e, then KSCM 140 may determine the frequency of the keyword “terrible” is ten. KSCM 140 may also determine the frequency of the keyword terrible is only three because it appears in three separate records: 124a, 124b, and 124e.

At step 330, in some embodiments, KSCM 140 generates a tree map based at least in part upon the frequency of the keyword and the significance of the keyword. KSCM 140 may determine the significance using one or more of the techniques discussed above with respect to steps 304-312 of FIG. 3. KSCM 140 may generate the tree map using the size of a rectangle to show the frequency of the keyword and the darkness of the shading of the rectangle to show the significance of the keyword. For example, the larger the rectangle the more frequent the first keyword appears in the plurality of records and the smaller the rectangle the less frequently it appears in the plurality of records 124. Similarly, the darker the shade of the rectangle, the higher the significance of the keyword and the lighter the rectangle, the lower the significance of the first keyword. An example of the tree map that could be generated at step 330 by KSCM 140 is shown in FIG. 2C and discussed above.

At step 332, in some embodiments, KSCM 140 communicates the tree map for display. KSCM 140 may communicate the a tree map from interface 165 to administrative workstation 150 via network 120. Administrator 151 may use the generated tree map to visually determine the keywords with the largest frequency and the highest significance, which indicates the highest risk to the enterprise. The method may then continue to either FIG. 3A, 3B, or 3D, or the method may end.

FIG. 3D illustrates an example flowchart for facilitating determining and comparing various risk scores of the same record. At step 334, in some embodiments, KSCM 140 determines that a second keyword appears in a record 124. In some embodiments, KSCM 140 may perform steps 302-314 of FIG. 3 and then KSCM 140 may scan one or more of the records 124 that contained the first keyword to determine whether any other keywords also appear in the record. For example, KSCM 140 may perform steps 302-314 for the keyword “system” and determine a significance of 0.35. Continuing the example, KSCM 140 may re-access record 124b (which contained at least one instance of the keyword “system”) and determine that the keyword “help” also appears in record 124b. In some embodiments, KSCM 140 re-access and scan all of the records 124 comprising the first keyword in order to determine what second keywords appear in all of those records 124. In some embodiments, KSCM 140 may receive a request from administrator 151 and administrator workstation 150 to determine whether a particular second keyword appears in any of the records 124 with the first keyword. For example, the request may include determining whether the keyword “global” appears in records 124 with the keyword “audit.”

At steps 336-342, in some embodiments, KSCM accesses a second record comprising the second keyword, determines a second risk score of the second record, assigns the second risk score as a keyword instance score for the second keyword, and determines the significance of the second keyword. KSCM 140 may perform these steps using one or more of the techniques discussed above with respect to steps 304-312 of FIG. 3. For example, if KSCM 140 already determined the significance of the keyword “terrible” and now wants to determine the significance of the keyword “global,” it would perform steps 336 to 340 to determine the significance of the keyword “global .”

At step 344 in some embodiments, KSCM 140 determines a second risk score of record 124 based at least in part upon the significance of the first keyword and the significance of the second keyword. For example, if administrator 151 wants to ensure that the scoring of record 124b based on the risk rating and risk rating scores, KSCM 140 may determine the significance of all the keywords contained in record 124b. Continuing the example, if record 124b is determined to have a risk score of 0.333 in step 308 of FIG. 3, and it contains the keyword “legal” with a significance of 0.9, the keyword “audit” with a significance of 0.75, and the keyword “system” with a significance of 0.88, then record 124b may require further analysis to ensure its score of 0.333 accurately reflects the items contained in record 124b.

In some embodiments, KSCM 140 may determine the second risk score of record 124 by adding the significance of the first keyword and the significance of the second keyword, multiplying them together, averaging them, or other more advanced calculations, such as Bayesian statistics. KSCM 140 may determine the second risk score of record 124 based in part upon the significance of a plurality of keywords. Determining a second risk score of record 124 allows administrator to have an update and a feedback loop to ensure that the original rating of record 124 is accurate. For example, when administrator 151 types up record 124 and determines it is a yellow risk rating, KSCM 140 may use that determination to calculate the record risk score of 0.333. By assessing the significance of a plurality of keywords that appear in record 124, KSCM 140 may determine a more accurate risk score of record 124. Continuing the example from above, KSCM 140 may determine the second (and updated) risk score of record 124b is the average of the significances of the keywords “legal,” “audit,” and “system” contained in record 124b (0.9+0.75+0.88=0.843). Because this updated risk score is not only based on a risk rating, but rather on the significance of the keywords contained in the record, KSCM 140 may determine a more accurate and reflective score for record 124.

At step 346 in some embodiments, KSCM 140 compares the risk score of record 124 to the second risk score of record 124. KSCM 140 may determine that the risk score is different than the second risk score (e.g., higher, lower, a certain amount higher or lower) or any suitable comparison of the two numbers. In certain embodiments, KSCM 140 may compare the two risk scores only if they are significantly different. For example, if the risk score of record 124b is 0.2 (e.g., based on it being categorized by administrator 151 as a green risk rating) and the second or updated risk score of record 124b is determined in step 344 to be 0.6, then KSCM 140 may determine that the second risk score is 0.4 higher than the original risk score. Continuing the example, KSCM 140 may update the risk score of record 124b to be 0.6 because it is a significant amount higher (0.4 higher) than the original risk score. In some embodiments, KSCM 140 may communicate this comparison to administrator 151 at administrator workstation 150. For example, KSCM 140 may automatically send a message if the risk scores on the ribbon threshold are different from each other or may send the comparison any time a comparison is performed. By allowing administrator 151 to view the comparison of the risk score and the second risk score, administrator 151 is able to update the record risk score as well as the risk scores associated with the risk rating of 124b. The method may continue to the steps in FIG. 3A, 3B, or 3C, or the method may end.

Modifications, additions, or omissions may be made to the methods described herein without departing from the scope of the invention. For example, the steps may be combined, modified, or deleted where appropriate, and additional steps may be added. For example, step 306 may be omitted and rather than determine an risk rating of dataset 125 associated with record 124, KSCM 140 determine the risk score of record 124 in step 308 by analyzing record 124 itself. Additionally, the steps may be performed in any suitable order without departing from the scope of the present disclosure. While discussed as KSCM 140 performing the steps, any suitable component of system 100, such as record risk score calculator 157, may perform one or more steps of the method.

Certain embodiments of the present disclosure may provide one or more technical advantages. In certain embodiments, a system for cross dataset keyword rating and analysis automatically updates the risk score of a record based on the significance of the keywords contained within the record, thereby conserving computational resources required to recalculate each risk score and constantly updating the accuracy of the system.

In certain embodiments, a system for cross dataset keyword rating and analysis generates information for display regarding the significance of one or more keywords that allow an administrator to readily identify the keywords with the largest significance. Which indicates the keywords associated with the most severe items the enterprise faces. This system conserves computational resources when comparing the significance of the keywords and allows an administrator to more readily identify the most significant keywords.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A keyword analysis system, comprising:
a memory operable to store a plurality of records, wherein the plurality of records comprises a first record;
an interface operable to:
receive a request to determine a significance of a first keyword;
access the first record comprising the first keyword;
one or more processors communicatively coupled to the interface and the memory and operable to:
determine a first risk score of the first record;
assign the first risk score of the first record as a first keyword instance score associated with the first keyword;
determine the significance of the first keyword based at least in part upon the first keyword instance score; and
analyze the significance of the first keyword.

2. The system of claim 1, wherein determining the first risk score of the first record comprises:
determining, using the processor, a risk rating of a dataset associated with the first record, the risk rating associated with a risk rating score; and
based at least in part upon the risk rating and the risk rating score, determining the first risk score of the first record.

3. The system of claim 1, wherein analyzing the significance of the keyword comprises:
determining, using the processor, a plurality of keyword instance scores associated with the first keyword, the plurality of keyword instance scores being determined from a plurality of records comprising the first keyword;
determining, using the processor, a distribution of the plurality of keyword instance scores; and
communicating information for display related to the distribution of the plurality of keyword instances scores.

4. The system of claim 1, wherein analyzing the significance of the first keyword comprises:
determining a frequency of the first keyword in a plurality of records comprising the first keyword;
generating a tree map based at least upon the frequency of the first keyword and the significance of the first keyword; and
communicating information related to the tree map for display.

5. The system of claim 1, wherein analyzing the significance of the first keyword comprises:
determining a second significance of the first keyword at a second time; and
comparing the significance of the first keyword to the second significance of the first keyword at the second time; and
communicating information for display related to the comparison of the significance and the second significance.

6. The system of claim 1, the one or more processors further operable to:
determine a second keyword that appears in the first record;
access a second record comprising the second keyword;
determine a second risk score of the second record;
assign the second risk score of the second record as a second keyword instance score associated with the second keyword;
determine a significance of the second keyword based at least in part upon the second keyword instance score;
determine a second risk score of the first record based at least in part upon the significance of the first keyword and a significance of the second keyword; and
compare the first risk score of the record to the second risk score of the record.

7. The system of claim 1, wherein the request to determine a significance of a first keyword comprises a request to determine a significance for each of a plurality of keywords.

8. A non-transitory computer-readable medium encoded with logic, the logic operable when executed to:
receive a request to determine a significance of a first keyword;
access a first record comprising the first keyword;
determine a first risk score of the first record;
assign the first risk score of the first record as a first keyword instance score associated with the first keyword;
determine the significance of the first keyword based at least in part upon the first keyword instance score; and
analyze the significance of the first keyword.

9. The computer-readable medium of claim 8, wherein the logic is further operable to:
determine a risk rating of a dataset associated with the first record, the risk rating associated with an risk rating score; and
based at least in part upon the risk rating and the risk rating score, determine the first risk score of the first record.

10. The computer-readable medium of claim 8, wherein the logic is further operable to:
determine a plurality of keyword instance scores associated with the first keyword, the plurality of keyword instance scores being determined from a plurality of records comprising the first keyword;
determine a distribution of the plurality of keyword instance scores; and
communicate information for display related to the distribution of the plurality of keyword instances scores.

11. The computer-readable medium of claim 8, wherein the logic is further operable to:
determine a frequency of the first keyword in a plurality of records comprising the first keyword;
generate a tree map based at least upon the frequency of the first keyword and the significance of the first keyword; and
communicate information related to the tree map for display.

12. The computer-readable medium of claim 8, wherein the logic is further operable to:
determine a second significance of the first keyword at a second time; and
compare the significance of the first keyword to the second significance of the first keyword at the second time; and
communicate information for display related to the comparison of the significance and the second significance.

13. The computer-readable medium of claim 8, wherein the logic is further operable to:
determine a second keyword that appears in the first record;
access a second record comprising the second keyword;
determine a second risk score of the second record;
assign the second risk score of the second record as a second keyword instance score associated with the second keyword;
determine a significance of the second keyword based at least in part upon the second keyword instance score;
determine a second risk score of the first record based at least in part upon the significance of the first keyword and a significance of the second keyword; and
compare the first risk score of the record to the second risk score of the record.

14. A keyword analysis method, comprising:
receiving a request to determine a significance of a first keyword;
accessing a first record comprising the first keyword;
determining, using a processor, a first risk score of the first record;
assigning, using the processor, the first risk score of the first record as a first keyword instance score associated with the first keyword;
determining, using the processor, the significance of the first keyword based at least in part upon the first keyword instance score; and
analyzing, using the processor, the significance of the first keyword.

15. The method of claim 14, wherein determining the first risk score of the first record comprises:
determining, using the processor, a risk rating of a dataset associated with the first record, the risk rating associated with a risk rating score; and
based at least in part upon the risk rating and the risk rating score, determining the first risk score of the first record.

16. The method of claim 15, further comprising determining, using the processor, the risk rating score associated with the risk rating by accessing a scale of a plurality of risk rating scores, wherein the scale is created by combining a plurality of rankings of a plurality of risk ratings from a plurality of datasets.

17. The method of claim 14, wherein analyzing the significance of the keyword comprises:
determining, using the processor, a plurality of keyword instance scores associated with the first keyword, the plurality of keyword instance scores being determined from a plurality of records comprising the first keyword;
determining, using the processor, a distribution of the plurality of keyword instance scores; and
communicating information for display related to the distribution of the plurality of keyword instances scores.

18. The method of claim 14, wherein analyzing the significance of the first keyword comprises:
determining a frequency of the first keyword in a plurality of records comprising the first keyword;
generating a tree map based at least upon the frequency of the first keyword and the significance of the first keyword; and
communicating information related to the tree map for display.

19. The method of claim 14, wherein analyzing the significance of the first keyword comprises:
determining a second significance of the first keyword at a second time; and
comparing the significance of the first keyword to the second significance of the first keyword at the second time; and
communicating information for display related to the comparison of the significance and the second significance.

20. The method of claim 14, further comprising:
determining, using the processor, a second keyword that appears in the first record;
accessing a second record comprising the second keyword;
determining, using the processor, a second risk score of the second record;
assigning, using the processor, the second risk score of the second record as a second keyword instance score associated with the second keyword;
determining, using the processor, a significance of the second keyword based at least in part upon the second keyword instance score;
determining, using the processor, a second risk score of the first record based at least in part upon the significance of the first keyword and a significance of the second keyword; and
comparing, using the processor, the first risk score of the record to the second risk score of the record.

21. The method of claim 14, wherein the request to determine a significance of a first keyword comprises a request to determine a significance for each of a plurality of keywords.
